(19) United States
(12) Patent Application Publication
(10) Pub. No.: US 2013/0141196 A1
(43) Pub. Date: Jun. 6, 2013

(54) RARE-EARTH PERMANENT MAGNET AND METHOD FOR MANUFACTURING RARE-EARTH PERMANENT MAGNET

(71) Applicants: Izumi Ozeki, Ibaraki-shi (JP); Katsuya Kume, Ibaraki-shi (JP); Toshiaki Okuno, Ibaraki-shi (JP); Takashi Ozaki, Ibaraki-shi (JP); Tomohiro Omure, Ibaraki-shi (JP); Keisuke Taihaku, Ibaraki-shi (JP)

(72) Inventors: Izumi Ozeki, Ibaraki-shi (JP); Katsuya Kume, Ibaraki-shi (JP); Toshiaki Okuno, Ibaraki-shi (JP); Takashi Ozaki, Ibaraki-shi (JP); Tomohiro Omure, Ibaraki-shi (JP); Keisuke Taihaku, Ibaraki-shi (JP)

(73) Assignee: NITTO DENKO CORPORATION, Ibaraki-shi, Osaka (JP)

(21) Appl. No.: 13/816,357

(22) PCT Filed: Mar. 15, 2012
(86) PCT No.: PCT/JP2012/056705

§ 371 Date: Feb. 11, 2013

(30) Foreign Application Priority Data
Jun. 24, 2011 (JP) 2011-140915
Jun. 24, 2011 (JP) 2011-140916

(51) Int. Cl. H01F 41/02; H01F 7/02

(52) U.S. Cl. CPC H01F 41/0266; H01F 7/02
USPC 335/302; 419/38

(57) ABSTRACT

There are provided a rare-earth permanent magnet and a manufacturing method thereof capable of achieving improvement of magnetic properties by optimizing magnetic field orientation. In the method, magnet material is milled into magnet powder. Next, the magnet powder and a binder are mixed to obtain a mixture. Next, the thus prepared mixture is formed into long-sheet-like shape so as to obtain a green sheet 13. Before the thus formed green sheet 13 dries, magnetic field is applied in an in-plane and transverse direction or an in-plane and machine direction of the green sheet for magnetic field orientation. Thereby, a permanent magnet 1 is obtained.

### TECHNICAL FIELD

The present invention relates to a rare-earth permanent magnet and a manufacturing method of the rare-earth permanent magnet.

### BACKGROUND ART

In recent years, a decrease in size and weight, an increase in power output and an increase in efficiency have been required in a permanent magnet motor used in a hybrid car, a hard disk drive, or the like. To realize such a decrease in size and weight, an increase in power output and an increase in efficiency in the permanent magnet motor mentioned above, film-thinning and a further improvement in magnetic performance have been required of a permanent magnet to be buried in the permanent magnet motor.

Here, as a method for manufacturing the permanent magnet used in the permanent magnet motor, a powder sintering method is generally used. In the powder sintering method as used herein, a raw material is first pulverized with a jet mill (dry-milling) to produce a magnet powder. Thereafter, the magnet powder is placed in a mold, and press molded to a desired shape. Then, the solid magnet powder molded into the desired shape is sintered at a predetermined temperature (for example, 1100 degrees Celsius in a case of an Nd—Fe—B-based magnet), thereby manufacturing the permanent magnet (for instance, Japanese Laid-open Patent Application Publication No. 2-266503). Further, for the purpose of improving the magnetic properties of a permanent magnet, magnetic field orientation is commonly performed by applying a magnetic field from outside. In the conventional powder sintering method for a permanent magnet, at press molding, magnet powder is put in a mold, exposed to a magnetic field for magnetic field orientation, and then pressurized, so that a compact body is formed. Further, the magnet is formed through being pressurized in an atmosphere exposed to a magnetic field, in other manufacturing method for a permanent magnet such as extrusion molding, injection molding, a roll forming method, and the like. Thereby, it becomes possible to obtain a formed body of the magnet powder having an easy axis of magnetization aligned in the magnetic-field-application direction.

### PRIOR ART DOCUMENT

### Patent Document

Patent document 1: Japanese Laid-open Patent Application
Publication No. 2-266503 (page 5)

### DISCLOSURE OF THE INVENTION

### Problem to be Solved by the Invention

However, when the permanent magnet is manufactured by the above-mentioned powder sintering method, there have been the following problems. That is to say, in the powder sintering method, it is necessary to secure a predetermined porosity in a press-molded magnet powder in order to perform magnetic field orientation. If the magnet powder having the predetermined porosity is sintered, it is difficult to uniformly contract at the time of sintering. Accordingly deformations such as warpage and depressions occur after sintering. Further, since pressure unevenness occurs at the time of pressing the magnet powder, the magnet is formed to have inhomogeneous density after sintering to generate distortion on a surface of the magnet. Conventionally, it has therefore been required to compression-mold the magnet powder to a larger size than that of a desired shape, assuming that the surface of the magnet has some distortion. Then, diamond cutting and polishing operations have been performed after sintering, for alteration to the desired shape. As a result, the number of manufacturing processes increases, and there also is a possibility of deteriorating qualities of the permanent magnet manufactured.

Specifically, when a thin-film magnet is cut out of a bulk body having a larger size as discussed above, material yield is significantly decreased. Further, a problem of large increase in man-hours has also been raised.

The present invention has been made in order to solve the above-mentioned conventional problems, and an object the invention is to provide a rare-earth permanent magnet and a manufacturing method of the rare-earth permanent magnet wherein deformations such warpage and depressions are suppressed in a sintered magnet by forming magnet powder into a shape of green sheet and applying magnetic field in an in-plane and transverse direction or an in-plane and machine direction of the green sheet having long length and the magnetic field orientation can be optimized while improving the magnetic properties of the permanent magnet.

### Means for Solving the Problem

To achieve the above object, the present invention provides a rare-earth permanent magnet manufactured through steps of: milling magnet material into magnet powder; preparing a mixture by mixing the magnet powder and a binder; obtaining a green sheet by forming the mixture into a long-sheet-like shape; applying magnetic field in an in-plane and transverse direction or an in-plane and machine direction of the green sheet for magnetic field orientation; and sintering the green sheet subjected to magnetic field orientation.

In the above-described rare-earth permanent magnet of the present invention, in the step of obtaining a green sheet, the green sheet is formed by applying the mixture to a surface of a substrate that is continuously conveyed, and in the step of applying magnetic field, magnetic field is applied to the green sheet that is continuously conveyed together with the substrate.

In the above-described rare-earth permanent magnet of the present invention, in the step of applying magnetic field, the green sheet conveyed together with the substrate is made to pass through a solenoid charged with electric current so as to apply magnetic field in the in-plane and machine direction of the green sheet for magnetic field orientation.

In the above-described rare-earth permanent magnet of the present invention, in the step of sintering the green sheet, the green sheet is pressure sintered.

In the above-described rare-earth permanent magnet of the present invention, before the step of sintering the green sheet, the binder is decomposed and removed from the green sheet by holding the green sheet for a predetermined length of time at binder decomposition temperature in a non-oxidizing atmosphere.

In the above-described rare-earth permanent magnet of the present invention, wherein, when decomposing and removing the binder from the green sheet, the green sheet is held for the predetermined length of time at temperature range of 200 degrees Celsius to 900 degrees Celsius in a hydrogen atmosphere or a mixed gas atmosphere of hydrogen and inert gas.

In the above-described rare-earth permanent magnet of the present invention, the mixture is slurry prepared by mixing the magnet powder, the binder and an organic solvent, and in the step of applying magnetic field, magnetic field is applied to the green sheet before the green sheet dries.

To achieve the above object, the present invention provides a manufacturing method of a rare-earth permanent magnet comprising the steps of: milling magnet material into magnet powder; preparing a mixture by mixing the magnet powder and a binder; obtaining a green sheet by forming the mixture into a long-sheet-like shape; applying magnetic field in an in-plane and transverse direction or an in-plane and machine direction of the green sheet for magnetic field orientation; and sintering the green sheet subjected to magnetic field orientation.

In the above-described manufacturing method of a rare-earth permanent magnet of the present invention, in the step of obtaining a green sheet, the green sheet is formed by applying the mixture to a surface of a substrate that is continuously conveyed, and in the step of applying magnetic field, magnetic field is applied to the green sheet that is continuously conveyed together with the substrate.

In the above-described manufacturing method of a rare-earth permanent magnet of the present invention, in the step of applying magnetic field, the green sheet conveyed together with the substrate is made to pass through a solenoid charged with electric current so as to apply magnetic field in the in-plane and machine direction of the green sheet for magnetic field orientation.

In the above-described manufacturing method of a rare-earth permanent magnet of the present invention, in the step of sintering the green sheet, the green sheet is pressure sintered.

In the above-described manufacturing method of a rare-earth permanent magnet of the present invention, before the step of sintering the green sheet, the binder is decomposed and removed from the green sheet by holding the green sheet for a predetermined length of time at binder decomposition temperature in a non-oxidizing atmosphere.

In the above-described manufacturing method of a rare-earth permanent magnet of the present invention, when decomposing and removing the binder from the green sheet, the green sheet is held for the predetermined length of time at temperature range of 200 degrees Celsius to 900 degrees Celsius in a hydrogen atmosphere or a mixed gas atmosphere of hydrogen and inert gas.

In the above-described manufacturing method of a rare-earth permanent magnet of the present invention, the mixture is slurry prepared by mixing the magnet powder, the binder and an organic solvent, and in the step of applying magnetic field, magnetic field is applied to the green sheet before the green sheet dries.

### Effect of the Invention

According to the rare-earth permanent magnet of the present invention, the permanent magnet is a sintered magnet made of a green sheet obtained by mixing magnet powder and a binder and forming the mixture into sheet-like shape. The thus sintered green sheet uniformly contracts and deformations such as warpage and depressions do not occur there. Further, the sintered green sheet having uniformly contracted gets pressed uniformly, which eliminates adjustment process to be conventionally performed after sintering and simplifies manufacturing process. Thereby, a permanent magnet can be manufactured with dimensional accuracy. Further, even if above such permanent magnets are made thin in the course of manufacturing, increase in the number of manufacturing processes can be avoided without lowering a material yield. Further, magnetic field orientation is performed by applying magnetic field in the in-plane and transverse direction or the in-plane and machine direction of the green sheet formed in a long-sheet-like shape. Accordingly, optimized magnetic field orientation can be performed and improvement of the magnetic properties of the permanent magnet is achieved. Further, there is no concern that the surface of the green sheet bristles up when the magnetic field is applied.

Further, according to the rare-earth permanent magnet of the present invention, the green sheet is formed by applying the mixture to a substrate that is continuously conveyed and magnetic field is applied to the green sheet that is continuously conveyed together with the substrate. Accordingly, continuous process can be exercised from the step of forming the green sheet till the step of orienting magnetic field. Thereby, the manufacturing process can be simplified and productivity can be improved.

Further, according to the rare-earth permanent magnet of the present invention, the green sheet conveyed together with the substrate is made to pass through a solenoid charged with electric current so as to apply magnetic field in the in-plane and machine direction of the green sheet for magnetic field orientation. Accordingly, homogeneous magnetic field can be applied to the green sheet and homogeneous and optimized magnetic field orientation can be performed.

Further, according to the rare-earth permanent magnet of the present invention, in the step of sintering the green sheet, the green sheet is pressure sintered. Pressure sintering makes it possible to lower sintering temperature so as to suppress the grain growth in sintering and magnetic performance can be improved.

Further, according to the rare-earth permanent magnet of the present invention, before the step of sintering the green sheet, the binder is decomposed and removed from the green sheet by holding the green sheet for a predetermined length of time at binder decomposition temperature in a non-oxidizing atmosphere. Thereby, carbon content in the magnet can be reduced previously. Consequently, previous reduction of carbon content can prevent alpha iron from separating out in a main phase of the sintered magnet and the entirety of the magnet can be sintered densely. Thereby, decrease in the coercive force can be prevented.

Further, according to the rare-earth permanent magnet of the present invention, the green sheet to which the binder has been mixed is held in a hydrogen atmosphere or a mixed gas atmosphere of hydrogen and inert gas. Thereby, carbon content in the magnet can be reduced reliably.

Further, according to the rare-earth permanent magnet of the present invention, in the step of applying magnetic field, magnetic field is applied to the green sheet before the green sheet dries. Therefore, optimized magnetic field orientation can be performed and improvement of the magnetic properties of the permanent magnet is achieved.

According to the manufacturing method of a rare-earth permanent magnet of the present invention, the permanent magnet is a sintered magnet made of a green sheet obtained by mixing magnet powder and a binder and forming the mixture into sheet-like shape. The thus sintered green sheet uniformly contracts and deformations such as warpage and depressions do not occur there. Further, the sintered green sheet having uniformly contracted gets pressed uniformly, which eliminates adjustment process to be conventionally performed after sintering and simplifies manufacturing process. Thereby, a permanent magnet can be manufactured with dimensional accuracy. Further, even if above such permanent magnets are made thin in the course of manufacturing, increase in the number of manufacturing processes can be avoided without lowering a material yield. Further, magnetic field orientation is performed by applying magnetic field in the in-plane and transverse direction or the in-plane and machine direction of the green sheet formed in a long-sheet-like shape. Accordingly, optimized magnetic field orientation can be performed and improvement of the magnetic properties of the permanent magnet is achieved. Further, there is no concern that the surface of the green sheet bristles up when the magnetic field is applied.

Further, according to the manufacturing method of a rare-earth permanent magnet of the present invention, the green sheet is formed by applying the mixture to a substrate that is continuously conveyed and magnetic field is applied to the green sheet that is continuously conveyed together with the substrate. Accordingly, continuous process can be exercised from the step of forming the green sheet till the step of orienting magnetic field. Thereby, the manufacturing process can be simplified and productivity can be improved.

Further, according to the manufacturing method of a rare-earth permanent magnet of the present invention, the green sheet conveyed together with the substrate is made to pass through a solenoid charged with electric current so as to apply magnetic field in the in-plane and machine direction of the green sheet for magnetic field orientation. Accordingly, homogeneous magnetic field can be applied to the green sheet and homogeneous and optimized magnetic field orientation can be performed.

Further, according to the manufacturing method of a rare-earth permanent magnet of the present invention, in the step of sintering the green sheet, the green sheet is pressure sintered. Pressure sintering makes it possible to lower sintering temperature so as to suppress the grain growth in sintering and magnetic performance can be improved.

Further, according to the manufacturing method of a rare-earth permanent magnet of the present invention, before the step of sintering the green sheet, the binder is decomposed and removed from the green sheet by holding the green sheet for a predetermined length of time at binder decomposition temperature in a non-oxidizing atmosphere. Thereby, carbon content in the magnet can be reduced previously. Consequently, previous reduction of carbon content can prevent alpha iron from separating out in a main phase of the sintered magnet and the entirety of the magnet can be sintered densely. Thereby, decrease in the coercive force can be prevented.

Further, according to the manufacturing method of a rare-earth permanent magnet of the present invention, the green sheet to which the binder has been mixed is held in a hydrogen atmosphere or a mixed gas atmosphere of hydrogen and inert gas. Thereby, carbon content in the magnet can be reduced reliably.

Further, according to the manufacturing method of a rare-earth permanent magnet of the present invention, in the step of applying magnetic field, magnetic field is applied to the green sheet before the green sheet dries. Therefore, optimized magnetic field orientation can be performed and improvement of the magnetic properties of the permanent magnet is achieved.

### BRIEF DESCRIPTION OF THE DRAWINGS

FIG. 1 is an overall view of a permanent magnet according to the invention.

FIG. 2 is a view depicting an effect at sintering on a basis of improved thickness precision in a green sheet according to the invention.

FIG. 3 is a view depicting a problem at sintering with lower thickness precision in the green sheet according to the invention.

FIG. 4 is an explanatory diagram illustrating a first manufacturing process of a permanent magnet according to the invention.

FIG. 5 is an explanatory diagram specifically illustrating a formation process of the green sheet in the first manufacturing process of the permanent magnet according to the invention.

FIG. 6 is an explanatory diagram specifically illustrating a magnetic field orientation process of the green sheet in the first manufacturing process of the permanent magnet according to the invention.

FIG. 7 is an explanatory diagram specifically illustrating a pressure sintering process of the green sheet in the first manufacturing process of the permanent magnet according to the invention.

FIG. 8 is an explanatory diagram illustrating a second manufacturing process of a permanent magnet according to the invention.

FIG. 9 is an explanatory diagram specifically illustrating a magnetic field orientation process of the green sheet in the second manufacturing process of the permanent magnet according to the invention.

FIG. 10 is a view depicting external appearances of green sheets according to an embodiment and a comparative example 1, respectively.

FIG. 11 is a scanning electron microscope (SEM) image of the green sheet according to the embodiment in close-up.

FIG. 12 is an inverse pole figure showing crystal orientation distribution in the green sheet according to the embodiment.

FIG. 13 is an SEM image of part of a formed body taken before sintering.

FIG. 14 is an SEM image of part of a permanent magnet manufactured according to the embodiment.

FIG. 15 is an SEM image of part of a permanent magnet manufactured according to a comparative example 2.

### BEST MODE FOR CARRYING OUT THE INVENTION

A specific embodiment of a rare-earth permanent magnet and a method for manufacturing the rare-earth permanent magnet according to the present invention will be described below in detail with reference to the drawings.

### Constitution of Permanent Magnet

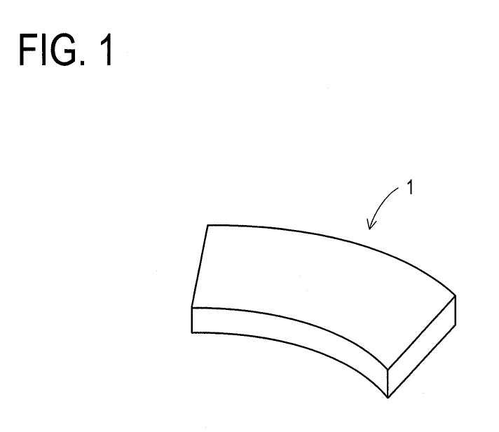

First, a constitution of a permanent magnet 1 according to the present invention will be described. FIG. 1 is an overall view of the permanent magnet 1 according to the present invention. Incidentally, the permanent magnet 1 depicted in FIG. 1 has a fan-like shape; however, the shape of the permanent magnet 1 may be changed according to the shape of a cutting-die.

As the permanent magnet 1 according to the present invention, an Nd—Fe—B-based magnet may be used. Incidentally, the contents of respective components are regarded as Nd: 27 to 40 wt %, B: 1 to 2 wt %, and Fe (electrolytic iron): 60 to 70 wt %. Furthermore, the permanent magnet 1 may include other elements such as Dy, Tb, Co, Cu, Al, Si, Ga, Nb, V, Pr, Mo, Zr, Ta, Ti, W, Ag, Bi, Zn or Mg in small amount, in order to improve the magnetic properties thereof. FIG. 1 is an overall view of the permanent magnet 1 according to the present embodiment.

The permanent magnet 1 as used herein is a thin film-like permanent magnet having a thickness of 0.05 to 10 mm (for instance, 1 mm), and is prepared by pressure sintering a formed body (a green sheet) formed into a sheet-like shape from a mixture (slurry or a powdery mixture) of magnet powder and a binder as described later.

Meanwhile, as the means for pressure sintering the green sheet, there are hot pressing, hot isostatic pressing (HIP), high pressure synthesis, gas pressure sintering, spark plasma sintering (SPS) and the like, for instance. However, it is desirable to adopt a method where sintering is performed in a shorter duration and at a lower temperature, so as to prevent grain growth of the magnet particles during the sintering. It is also desirable to adopt a sintering method capable of suppressing warpage formed in the sintered magnets. Accordingly, specifically in the present invention, it is preferable to adopt the SPS method which is uniaxial pressure sintering in which pressure is uniaxially applied and also in which sintering is performed by electric current sintering, from among the above sintering methods.

Here, the SPS method is a method of heating a graphite sintering die with a sintering object arranged inside while pressurizing in a uniaxial direction. The SPS method utilizes pulse heating and mechanical pressure application, so that the sintering is driven complexly by electromagnetic energy by pulse conduction, self-heating of the object to be processed and spark plasma energy generated among particles, in addition to thermal or mechanical energy used for ordinary sintering. Accordingly, quicker heating and cooling can be realized, compared with atmospheric heating by an electric furnace or the like, and sintering at a lower temperature range can also be realized. As a result, the heating-up and holding periods in the sintering process can be shortened, making it possible to manufacture a densely sintered body in which grain growth of the magnet particles is suppressed. Further, the sintering object is sintered while being pressurized in a uniaxial direction, so that the warpage after sintering can be suppressed.

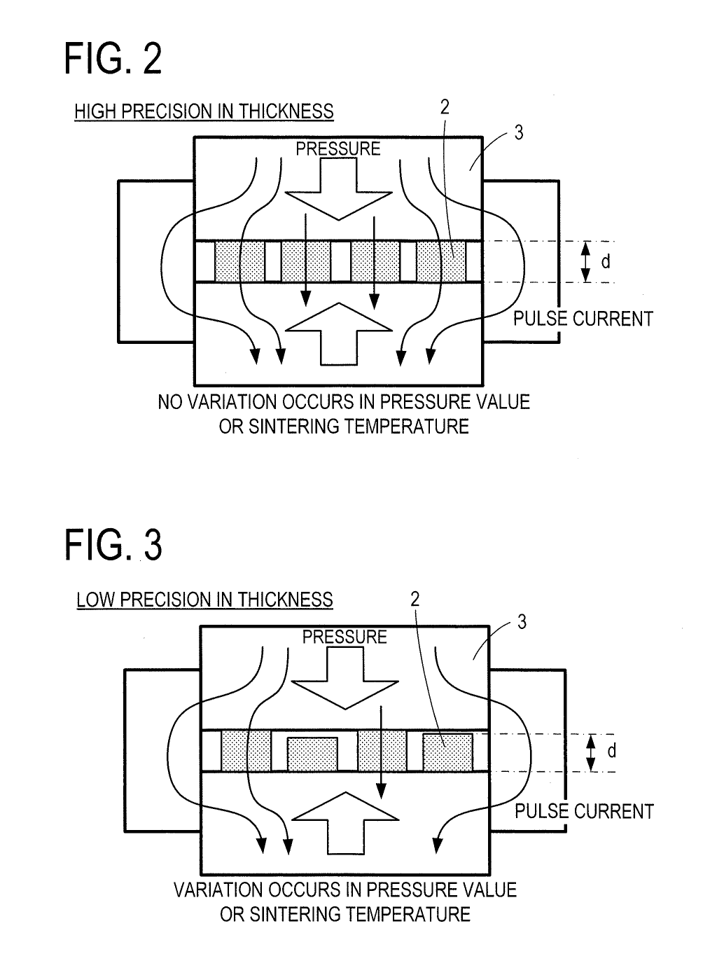

Furthermore, the green sheet is die-cut into a desired product shape (for instance, a fan-like shape shown in FIG. 1) to obtain a formed body and the formed body is arranged inside the sintering die of the SPS apparatus, upon executing the SPS method. According to the present invention, a plurality of formed bodies (for instance, ten formed bodies) 2 are arranged inside the sintering die 3 at a time, as depicted in FIG. 2, in order to boost the productivity. Here, in the present invention, the green sheet is configured to have thickness precision within a margin of error of plus or minus 5%, preferably plus or minus 3%, or more preferably plus or minus 1%, with reference to a designed value. As a result, according to the present invention, as the thickness d of each formed body 2 is uniform, there are no variations in proper pressure values or proper heating temperatures of respective formed bodies 2 and the sintering can be performed satisfactorily even in a case where a plurality of formed bodies (for instance, ten formed bodies) 2 are arranged inside the sintering die 3 and sintered at a time, as illustrated in FIG. 2. Meanwhile, if the green sheet is formed with low precision in thickness (for instance, more than plus or minus 5% with reference to the designed value), the thickness d of each formed body 2 is not uniform in the case where a plurality of formed bodies (for instance, ten formed bodies) 2 are arranged inside the sintering die 3 and sintered at a time as illustrated in FIG. 3. Accordingly, imbalanced pulse current passes through the respective formed bodies 2 and there occur variations in proper pressure values or proper heating temperatures and the sintering cannot be performed satisfactorily. Incidentally, in the case where the plurality of formed bodies 2 are simultaneously sintered, there may be employed an SPS apparatus having a plurality of sintering dies. There, formed bodies 2 may be respectively placed in the plurality of sintering dies of the SPS apparatus and then simultaneously sintered.

In the present invention, when preparing a green sheet, resin, long-chain hydrocarbon, fatty acid methyl ester or a mixture thereof is used as the binder to be mixed with the magnet powder.

Further, if the resin is used as the binder, there are preferably used, for instance, polyisobutylene (PIB), butyl rubber (IIR), polyisoprene (IR), polybutadiene, polystyrene, styrene-isoprene block copolymer (SIS), styrene-butadiene block copolymer (SBS), Poly(2-methyl-1-pentene), poly(2-methyl-1-butene), poly(alpha-methylstyrene), polybutylmethacrylate, polymethylmethacrylate, etc. Incidentally, low molecular weight polyisobutylene is preferably added to the poly(alpha-methylstyrene) to produce flexibility. Further, as resin used for the binder, there are preferably used a polymer containing no oxygen and exhibiting depolymerization property (for instance, polyisobutylene, etc) to reduce the oxygen content contained in the magnet.

Incidentally, in a case slurry-molding is used for forming the green sheet, the binder is preferably made of a resin excluding polyethylene and polypropylene so that the binder can get dissolved in a general purpose solvent such as toluene or like. Meanwhile, in a case hot-melt molding is employed for forming the green sheet, a thermoplastic resin is preferably used for the convenience of performing magnetic field orientation using the formed green sheet in a heated and softened state.

Meanwhile, in a case a long-chain hydrocarbon is used for the binder, there is preferably used a long-chain saturated hydrocarbon (long-chain alkane) being solid at room temperature and being liquid at a temperature higher than the room temperature. Specifically, a long-chain saturated hydrocarbon whose carbon number is 18 or more is preferably used. In the case of using the hot melt molding when forming the green sheet, the magnetic field orientation of the green sheet is performed in a state where the green sheet is heated to soften at a temperature higher than the melting point of the long-chain hydrocarbon.

In a case where a fatty acid methyl ester is used for the binder, there are preferably used methyl stearate, methyl docosanoate, etc., being solid at room temperature and being liquid at a temperature higher than the room temperature in similar with long-chain saturated hydrocarbon. In the case of using the hot melt molding when forming the green sheet, the magnetic field orientation of the green sheet is performed in a state where the green sheet is heated to be softened at a temperature higher than the melting point of fatty acid methyl ester.

Further, the amount of the binder to be added is an appropriate amount to fill the gaps between magnet particles so that thickness precision of the sheet can be improved when forming the mixture of the magnet powder and the binder into a sheet-like shape. For instance, the binder proportion to the amount of magnet powder and binder in total in the slurry after the addition of the binder is preferably 1 to 40 wt %, more preferably 2 to 30 wt %, or still more preferably 3 to 20 wt %.

### [First Method for Manufacturing Permanent Magnet]

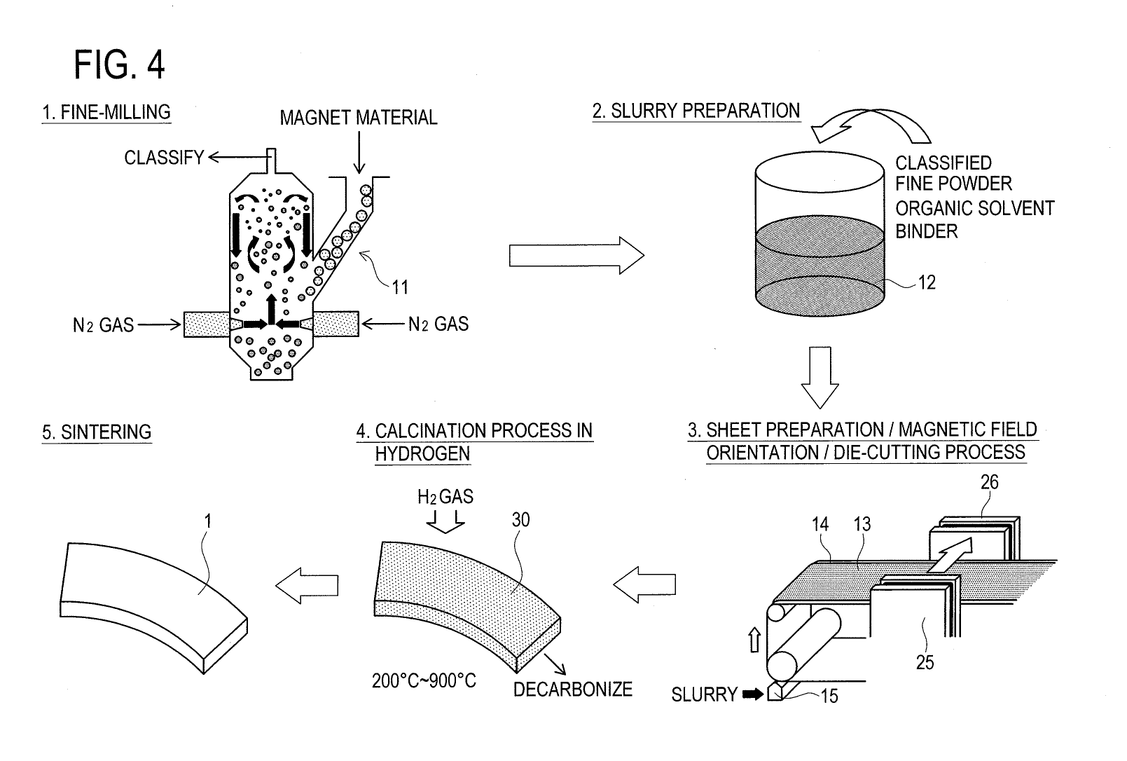

Next, a first method for manufacturing the permanent magnet 1 according to the present invention will be described below with reference to FIG. 4. FIG. 4 is an explanatory view illustrating a first manufacturing process of the permanent magnet 1 according to the present invention.

First, there is manufactured an ingot comprising Nd—Fe—B of certain fractions (for instance, Nd: 32.7 wt %, Fe (electrolytic iron): 65.96 wt %, and B: 1.34 wt %). Thereafter the ingot is coarsely milled using a stamp mill, a crusher, etc. to a size of approximately 200 μm. Otherwise, the ingot is dissolved, formed into flakes using a strip-casting method, and then coarsely milled using a hydrogen pulverization method.

Next, the coarsely milled magnet powder is finely milled with a jet mill 11 to form fine powder of which the average particle diameter is smaller than a predetermined size (for instance, 1.0 μm through 5.0 μm) in: (a) an atmosphere composed of inert gas such as nitrogen gas, argon (Ar) gas, helium (He) gas or the like having an oxygen content of substantially 0%; or (b) an atmosphere composed of inert gas such as nitrogen gas, Ar gas, He gas or the like having an oxygen content of 0.0001 through 0.5%. Here, the term “having an oxygen content of substantially 0%” is not limited to a case where the oxygen content is completely 0%, but may include a case where oxygen is contained in such an amount as to allow a slight formation of an oxide film on the surface of the fine powder. Incidentally, wet-milling may be employed for a method for milling the magnet material. For instance, in a wet method using a bead mill, using toluene as a solvent, coarsely milled magnet powder may be finely milled to a predetermined size (for instance, 0.1 μm through 5.0 μm). Thereafter, the magnet powder contained in the organic solvent after the wet milling may be desiccated by such a method as vacuum desiccation to obtain the desiccated magnet powder. There may be configured to add and knead the binder to the organic solvent after the wet milling without removing the magnet powder from the organic solvent to obtain later described slurry 12.

Through using the above wet-milling, the magnetic material can be milled into still smaller grain sizes than those in the dry-milling. However, if the wet-milling is employed, there rises a problem of residual organic compounds in the magnet due to the organic solvent, even if the later vacuum desiccation vaporizes the organic solvent. However, this problem can be solved by removing carbons from the magnet through performing the later-described calcination process to decompose the organic compounds remaining with the binder by heat.

Meanwhile, a binder solution is prepared for adding to the fine powder finely milled by the jet mill 11 or the like. Here, as mentioned above, there can be used a resin, a long-chain hydrocarbon, fatty acid methyl ester or a mixture thereof as binder. Then, binder solution is prepared through dissolving the binder into a solvent. The solvent to be used for dissolving is not specifically limited, and may include: alcohols such as isopropyl alcohol, ethanol and methanol; lower hydrocarbons such as pentane and hexane; aromatic series such as benzene, toluene and xylene; esters such as ethyl acetate; ketones; and a mixture thereof. However, toluene or ethyl acetate is used here.

Successively, the above binder solution is added to the fine powder classified at the jet mill 11. Through this, slurry 12 in which the fine powder of magnet raw material, the binder and the organic solvent are mixed is prepared. Here, the amount of binder solution to be added is preferably such that binder proportion to the amount of magnet powder and binder in total in the slurry after the addition is 1 to 40 wt %, more preferably 2 to 30 wt %, or still more preferably 3 to 20 wt %. For instance, 100 grams of 20 wt % binder solution is added to 100 grams of the magnet powder to prepare the slurry 12. Here, the addition of the binder solution is performed in an atmosphere composed of inert gas such as nitrogen gas, Ar gas or He gas.

Subsequently, from the thus produced slurry 12, there is formed a green sheet 13 which has a long-sheet-like shape. The green sheet 13 may be formed by, for instance, a coating method in which the produced slurry 12 is spread on a supporting substrate 14 such as a separator as needed by an appropriate system and then desiccated. Incidentally, the coating method is preferably a method excellent in layer thickness controllability, such as a doctor blade system, a slot-die system, or a comma coating system. For realizing thickness precision, a slot-die system or a comma coating system is especially favorable as being excellent in layer thickness controllability (namely, as being a method capable of applying a layer with accurate thickness on a surface of a substrate). For instance, the following embodiment adopts a slot-die system. As supporting substrate 14, a silicone-treated polyester film is used. Further, a defoaming agent may preferably be used in conjunction therewith to sufficiently perform defoaming treatment so that no air bubbles remain in a spread layer.

Further, before drying the green sheet 13 coated on supporting substrate 14, magnetic field orientation is performed by applying magnetic field in an in-plane and transverse direction or an in-plane and machine direction of the green sheet 13 that is being conveyed. The intensity of the applied magnetic field is 5000[Oe] through 150000[Oe], or preferably 10000[Oe] through 120000[Oe].

The green sheet 13 subjected to magnetic field orientation is dried by holding it at 90 degrees Celsius for 10 minutes and subsequently at 130 degrees Celsius for 30 minutes.

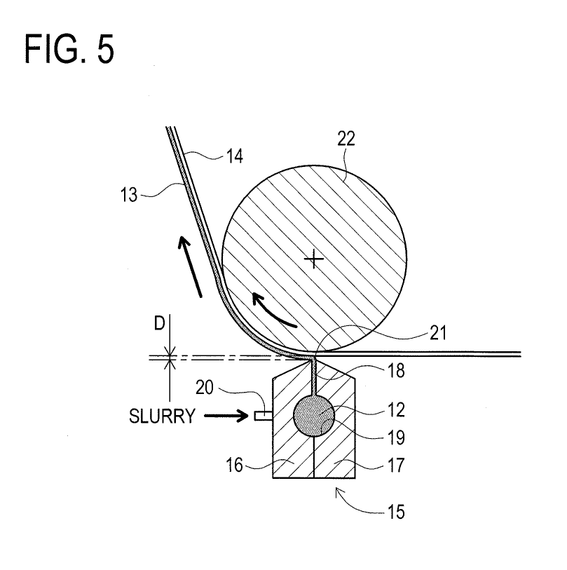

Here will be given a detailed description of the formation process of a green sheet 13 using a slot-die system referring to FIG. 5. FIG. 5 is an explanatory diagram illustrating the formation process of the green sheet 13 using the slot-die system.

As illustrated in FIG. 5, a slot die 15 used for the slot-die system is formed by putting blocks 16 and 17 together. There, a gap between the blocks 16 and 17 serves as a slit 18 and a cavity (liquid pool) 19. The cavity 19 communicates with a die inlet 20 formed in the block 17. Further, the die inlet 20 is connected with a slurry feed system configured with a metering pump and the like (not shown), and the cavity 19 receives the feed of metered slurry 12 through the die inlet 20 by the metering pump and the like. Further, the slurry 12 fed to the cavity 19 is delivered to the slit 18, and discharged at a predetermined coating width from a discharge outlet 21 of the slit 18, with a pressure which is uniform in transverse direction in a constant amount per unit of time. Meanwhile, a supporting substrate 14 is conveyed along the rotation of a coating roll 22 at a predetermined speed. As a result, the discharged slurry 12 is laid down on the supporting substrate 14 with a predetermined thickness. Thus, a long-sheet-like green sheet 13 is formed.

Further, in the formation process of the green sheet 13 by the slot-die system, it is desirable to measure the actual sheet thickness of the green sheet 13 after coating, and to perform feed back control of a gap D between the slot die 15 and the supporting substrate 14 based on the measured thickness. Further, it is desirable to minimize the variation in feed rate of the slurry supplied to the slot die 15 (for instance, suppress the variation within plus or minus 0.1%), and in addition, to also minimize the variation in coating speed (for instance, suppress the variation within plus or minus 0.1%). As a result, thickness precision of the green sheet can further be improved. Incidentally, the thickness precision of the formed green sheet is within a margin of error of plus or minus 5% with reference to a designed value (for instance, 1 mm), preferably within plus or minus 3%, or more preferably within plus or minus 1%.

Incidentally, a preset thickness of the green sheet 13 is desirably within a range of 0.05 mm through 10 mm. If the thickness is set to be thinner than 0.05 mm, it becomes necessary to accumulate many layers, which lowers the productivity. Meanwhile, if the thickness is set to be thicker than 10 mm, it becomes necessary to decrease the drying rate so as to inhibit air bubbles from forming at drying, which significantly lowers the productivity.

Further, when mixing the magnet powder with the binder, the mixture may be made into not the slurry 12, but a mixture in the form of powder (hereinafter referred to as a powdery mixture) made of the magnet powder and the binder without adding the organic solvent. There may be employed hot melt coating in which the powdery mixture is heated to melt, and turns into a fluid state and then is spread onto the supporting substrate 14 such as the separator. The mixture spread by the hot melt coating is left to cool and solidify, so that the green sheet 13 can be formed in a long sheet fashion on the supporting substrate 14. Incidentally, the temperature for heating and melting the powdery mixture differs depending on the kind or amount of binder to be used, but is set here at 50 through 300 degrees Celsius. However, it is necessary to set the temperature higher than the melting point of the binder to be used. Here, in order to mix the magnet powder and the binder together, the magnet powder and the binder are, for instance, respectively put into an organic solvent and stirred with a stirrer. After stirring, the organic solvent containing the magnet powder and the binder is heated to vaporize the organic solvent, so that the powdery mixture is extracted. Further, specifically when the magnet powder is milled by a wet method, there may be employed a configuration in which, without isolating the magnet powder out of an organic solvent used for the milling, the binder is added to the organic solvent and kneaded, and thereafter the organic solvent is vaporized to obtain the powdery mixture.

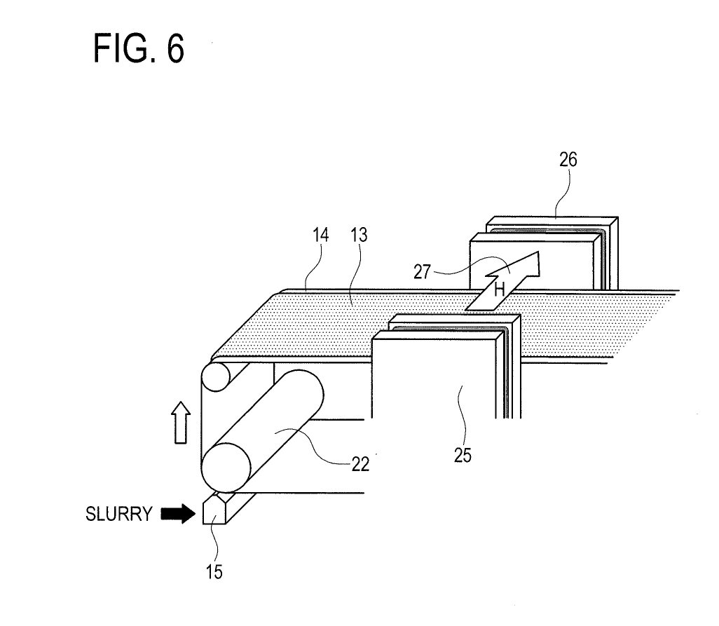

Next, there will be described on a magnetic field orientation process of the green sheet 13 in detail by referring to FIG. 6. FIG. 6 is an explanatory diagram illustrating a magnetic field orientation process of the green sheet 13.

As shown in FIG. 6, magnetic field orientation is performed on the green sheet 13 having been coated by the above described slot-die system. More specifically, before the green sheet 13 dries, magnetic field orientation is performed on the green sheet 13 that is long-sheet-like shaped and continuously conveyed by a roll. That is, an apparatus for magnetic field orientation is arranged at downstream side of a coating apparatus (slot-die apparatus or the like) so as to perform magnetic field orientation subsequent to the coating process.

More specifically, a pair of magnetic coils 25 and 26 are arranged at the left and right sides for the green sheet 13 and the supporting substrate 14 to be conveyed together, at downstream side for the slot die 15 and the coating roll 22. By applying electrical current to each of the magnetic coils 25 and 26, magnetic field is generated in an in-plane direction (i.e., direction in parallel with a sheet surface of the green sheet 13) and transverse direction of the long-sheet-like shaped green sheet 13. Thus, magnetic field is applied to the continuously-conveyed green sheet 13 in the in-plane and transverse direction of the green sheet 13 (arrow 27 direction in FIG. 5). Thereby, homogeneous and optimized magnetic field orientation can be performed on the green sheet 13. Especially, application of magnetic field in the in-plane direction thereof can prevent the surface of the green sheet 13 from bristling up. Further, in a case the green sheet 13 is guided to an inhomogeneous magnetic field condition, the powder contained in the green sheet 14 is attracted to stronger magnetic field, resulting in imbalanced distribution of liquid slurry to consequently form a green sheet 13 with problematic unevenness in thickness. Therefore, for making sheet thickness uniform, orientation process may be performed intermittently.

Further, desiccation of the green sheet 13 subjected to magnetic field orientation is preferably performed in the state of being conveyed for the sake of efficiency at manufacturing processes.

Incidentally, if the green sheet is formed by the hot melt molding, the magnetic field orientation of the green sheet is performed in a state where the green sheet is heated to soften in a temperature above the glass transition point or the melting point of the binder. Further, the magnetic field orientation may be performed before the formed green sheet has congealed.

Then, the green sheet 13 is die-cut into a desired product shape (for example, the fan-like shape shown in FIG. 1) to form a formed body 30.

Thereafter, the formed body 30 thus formed is held at a binder-decomposition temperature for several hours (for instance, five hours) in a non-oxidizing atmosphere (specifically in this invention, a hydrogen atmosphere or a mixed gas atmosphere of hydrogen and inert gas) and a calcination process in hydrogen is performed. The hydrogen feed rate during the calcination is, for instance, 5 L/min, if the calcination is performed in the hydrogen atmosphere. By the calcination process in hydrogen, the binder can be decomposed into monomers through depolymerization reaction, released therefrom and removed. Namely, so-called decarbonization is performed in which carbon content in the formed body 30 is reduced. Furthermore, calcination process in hydrogen is to be performed under such a condition that carbon content in the formed body 30 is 1500 ppm or lower, or more preferably 1000 ppm or lower. Accordingly, it becomes possible to densely sinter the permanent magnet 1 as a whole in the following sintering process, and the decrease in the residual magnetic flux density or in the coercive force can be prevented.

The binder-decomposition temperature is determined based on the analysis of the binder decomposition products and decomposition residues. In particular, the temperature range to be selected is such that, when the binder decomposition products are trapped, no decomposition products except monomers are detected, and when the residues are analyzed, no products due to the side reaction of remnant binder components are detected. The temperature differs depending on the type of binder, but may be set at 200 through 900 degrees Celsius, or more preferably 400 through 600 degrees Celsius (for instance, 600 degrees Celsius).

Further, in a case the magnet raw material is milled in an organic solvent by wet-milling, the calcination process is performed at a decomposition temperature of the organic compound composing the organic solvent as well as the binder decomposition temperature. Accordingly, it is also made possible to remove the residual organic solvent. The decomposition temperature for an organic compound is determined based on the type of organic solvent to be used, but basically the organic compound can be thermally decomposed in the above binder decomposition temperature.

Thereafter, a sintering process is performed in which the formed body 30 calcined in the calcination process in hydrogen is sintered. In the present invention, pressure sintering is applied to the calcined formed body 30. The pressure sintering includes, for instance, hot pressing, hot isostatic pressing (HIP), high pressure synthesis, gas pressure sintering, spark plasma sintering (SPS) and the like. However, it is preferable to adopt the spark plasma sintering which is uniaxial pressure sintering in which pressure is uniaxially applied and also in which sintering is preformed by electric current sintering so as to prevent grain growth of the magnet particles during the sintering and also to prevent warpage formed in the sintered magnets.

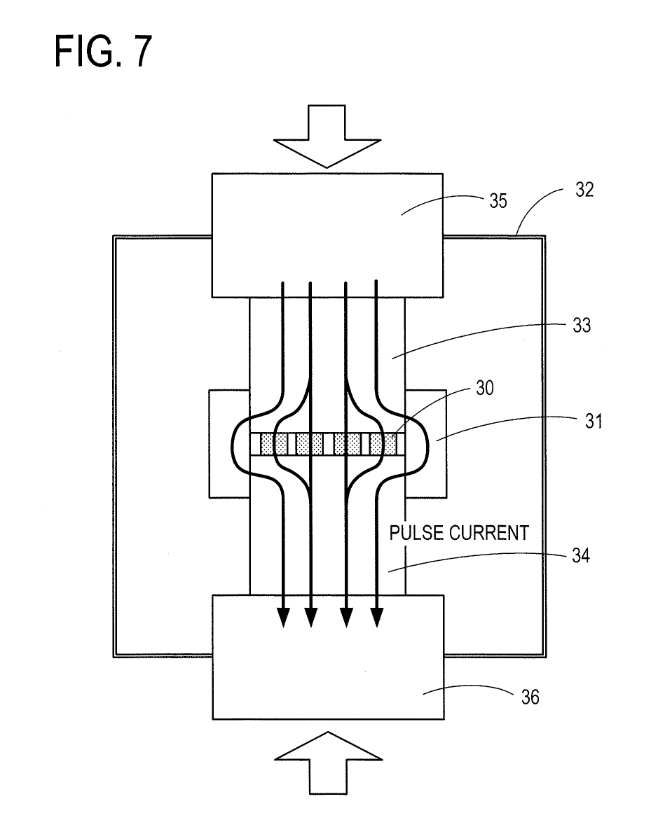

Here will be given a detailed description of the pressure sintering process of a formed body 30 using the SPS method, referring to FIG. 7. FIG. 7 is a schematic diagram depicting the pressure sintering process of the formed body 30 using the SPS method.

When performing the spark plasma sintering as illustrated in FIG. 7, first, the formed body 30 is put in a graphite sintering die 31. Incidentally, the above calcination process in hydrogen may also be performed under the state where the formed body 30 is put in the sintering die 31. Then, the formed body 30 put in the sintering die 31 is held in a vacuum chamber 32, and an upper punch 33 and a lower punch 34 also made of graphite are set thereat. After that, using an upper punch electrode 35 coupled to the upper punch 33 and a lower punch electrode 36 coupled to the lower punch 34, pulsed DC voltage/current being low voltage and high current is applied. At the same time, a load is applied to the upper punch 33 and the lower punch 34 from upper and lower directions using a pressurizing mechanism (not shown). As a result, the formed body 30 put inside the sintering die 31 is sintered while being pressurized. Further, the spark plasma sintering is preferably executed to a plurality of formed bodies (for instance, ten formed bodies) 30 simultaneously, so that the productivity may be improved. Incidentally, at the simultaneous spark plasma sintering to the plurality of formed bodies 30, the plurality of formed bodies 30 may be put in one sintering die 31, or may be arranged in different sintering dies 31, respectively. Incidentally, in the case that the plurality of formed bodies 25 are respectively arranged in different sintering dies 31, an SPS apparatus provided with a plurality of sintering dies 31 is used to execute sintering. There, the upper punch 33 and the lower punch 34 for pressing the formed bodies 25 are configured to be integrally used for the plurality of sintering dies 31 (so that the pressure can be applied simultaneously by the upper punch 33 and the lower punch 34) which are integrally-moving).

Incidentally, the detailed sintering condition is as follows:
Pressure value: 30 MPa
Sintering temperature: risen by 10 deg. C. per min. up to 940 deg. C. and held for 5 min.
Atmosphere: vacuum atmosphere of several Pa or lower.

After the spark plasma sintering, the formed body 30 is cooled down, and again undergoes a heat treatment in 600 through 1000 degrees Celsius for two hours. As a result of the sintering, the permanent magnet 1 is manufactured.

### [Second Method for Manufacturing Permanent Magnet]

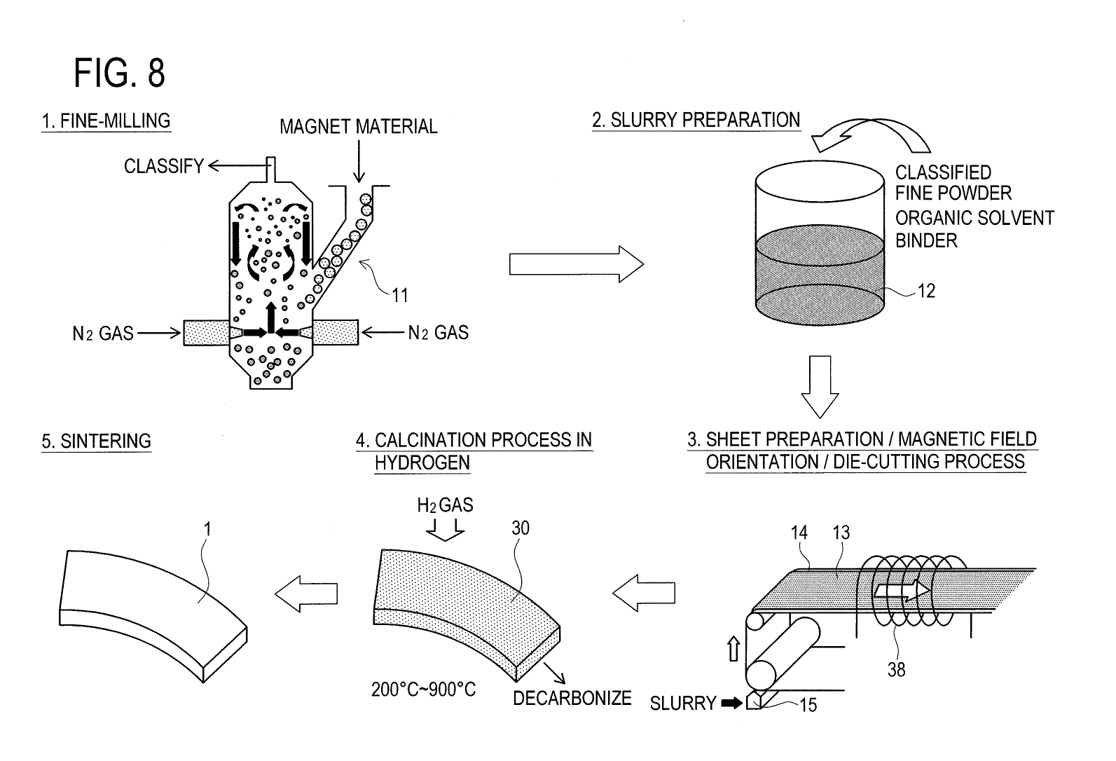

Next, a second method for manufacturing the permanent magnet 1 according to the present invention will be described below with reference to FIG. 8. FIG. 8 is an explanatory view illustrating a second manufacturing process of the permanent magnet 1 according to the present invention.

The second manufacturing process of the permanent magnet 1 differs in magnetic field orientation process from the first manufacturing process. That is, in the first manufacturing process, the magnetic field orientation is performed through applying a magnetic field in the in-plane and transverse direction of the green sheet 13 while, in the second manufacturing process, the magnetic field orientation is performed through applying a magnetic field in the in-plane and machine direction of the green sheet 13.

The process up to the formation of the green sheet 13 on the supporting substrate 14 is the same as in the first manufacturing method, and hence will not be discussed here.

In the second manufacturing method of the permanent magnet 1, before drying the green sheet 13 coated on the supporting substrate 14, magnetic field orientation is performed by applying magnetic field in an in-plane and machine direction of the green sheet 13 that is being conveyed. The intensity of the applied magnetic field is 5000[Oe] through 150000 [Oe], or preferably 10000 [Oe] through 120000 [Oe].

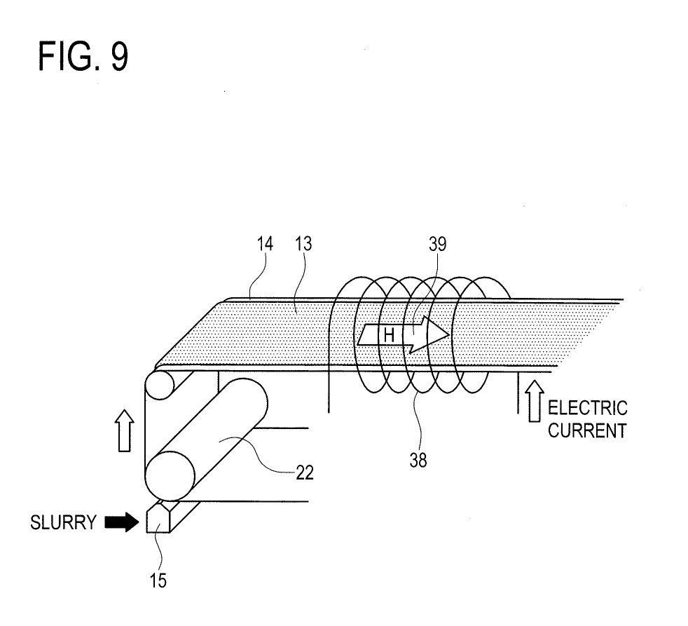

Next, there will be described on a magnetic field orientation process of the green sheet 13 in the second manufacturing method in detail referring to FIG. 9. FIG. 9 is an explanatory diagram illustrating a magnetic field orientation process of the green sheet 13.

As shown in FIG. 9, magnetic field orientation is performed on the green sheet 13 having been coated by the above described slot-die system. More specifically, before the green sheet 13 dries, magnetic field orientation is performed on the green sheet 13 that is long-sheet-like shaped and continuously conveyed by a roll. That is, an apparatus for magnetic field orientation is arranged at downstream side of a coating apparatus (slot-die apparatus or the like) so as to perform magnetic field orientation subsequent to the coating process.

More specifically, a solenoid 38 is arranged at the downstream side for the slot die 15 and the coating roll 22 with reference to the green sheet 13 and the supporting substrate 14 to be conveyed together so that the green sheet 13 and the supporting substrate 14 pass through the solenoid 38. By applying electrical current to the solenoid 38, magnetic field is generated in an in-plane direction (i.e., direction in parallel with a sheet surface of the green sheet 13) and machine direction of the long-sheet-like shaped green sheet 13. Thus, magnetic field is applied to the continuously-conveyed green sheet 13 in the in-plane and machine direction of the green sheet 13 (arrow 39 direction in FIG. 9). Thereby, homogeneous and optimized magnetic field orientation can be performed on the green sheet 13. Especially, application of magnetic field in the in-plane direction thereof can prevent surface of the green sheet 13 from bristling up. Further, in a case the green sheet 13 is guided to an inhomogeneous magnetic field condition, the powder contained in the green sheet 14 is attracted to stronger magnetic field, resulting in imbalanced distribution of liquid slurry to consequently form the green sheet 13 with problematic unevenness in thickness. Therefore, for making sheet thickness uniform, orientation process may be performed intermittently.

Further, desiccation of the green sheet 13 subjected to magnetic field orientation is preferably performed in the state of being conveyed for the sake of efficiency at manufacturing processes.

Incidentally, if the green sheet is formed by the hot melt molding, the magnetic field orientation of the green sheet is performed in a state where the green sheet is heated to soften in a temperature above the glass transition point or the melting point of the binder. Further, the magnetic field orientation may be performed before the formed green sheet has congealed.

The green sheet 13 subjected to magnetic field orientation is dried by holding it at 90 degrees Celsius for 10 minutes and subsequently at 130 degrees Celsius for 30 minutes.

Then, in similar with the first manufacturing method, the green sheet 13 is die-cut into a desired product shape (for example, the fan-like shape shown in FIG. 1). Subsequently, calcination process and sintering process are performed to the thus formed body so as to form a permanent magnet 1.

### EMBODIMENT

Here will be described on an embodiment according to the present invention referring to comparative examples for comparison.

### Embodiment

In the embodiment, there is used an Nd—Fe—B-based magnet and alloy composition thereof is Nd/Fe/B=32.7/65.96/1.34 in wt%. Polyisobutylene as binder and toluene as solvent have been used to obtain slurry so that the binder contained in the slurry accounts for 18 wt % with reference to total of the magnet powder and binder. After that, the substrate is coated with the slurry by a slot-die system so as to obtain a green sheet. Further, magnetic field orientation is performed through applying a 1.1 T magnetic field to the green sheet in the in-plane and transverse direction or in the in-plane and machine direction. After calcination process, the green sheet has been sintered by SPS method (at pressure value of 30 MPa, raising sintering temperature by 10 degrees Celsius per minutes up to 940 degrees Celsius and holding it for 5 minutes). Other processes are the same as the processes in [First Method for Manufacturing Permanent Magnet] or [Second Method for Manufacturing Permanent Magnet] mentioned above.

### Comparative Example 1

The magnetic field orientation is performed through applying a 1.1 T magnetic field to the green sheet 13 in an out-of-plane direction (a direction perpendicular to the sheet surface of the green sheet 13). Other conditions are the same as the embodiment.

### Comparative Example 2

The green sheet is sintered by an electric furnace in He atmosphere instead of using the SPS method. More specifically, sintering is performed through heating the electric furnace up to approximately 800 to 1200 degrees Celsius (e.g., 1000 degrees Celsius) at predetermined temperature rising speed and holding it for about two hours. Other conditions are the same as the embodiments.

### (Comparison of Embodiment and Comparative Example 1)

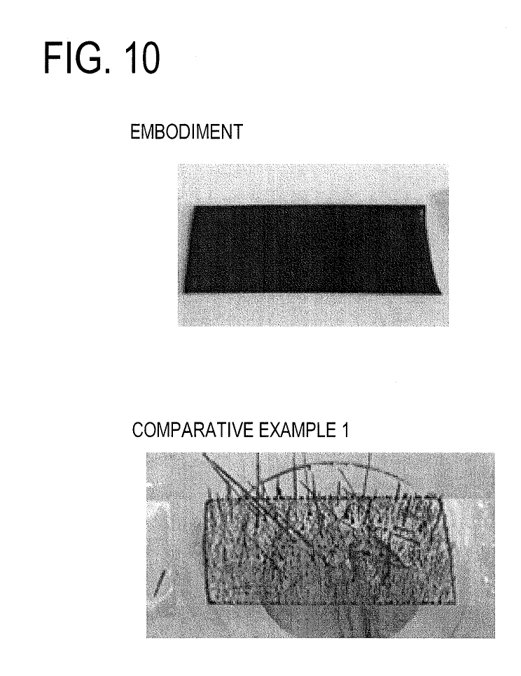

Here, FIG. 10 comparatively depicts external appearances of green sheets of the embodiment and the comparative example 1 after magnetic field orientation, respectively. Comparing the appearances of the permanent magnets of the embodiment and the comparative example 1 in FIG. 10, there is observed the surface bristling up with respect to the permanent magnet of the comparative example 1. Whereas, with respect to the surface of permanent magnet of the embodiment, there is not observed such a surface bristling up like the comparative example 1. Accordingly, the sintered permanent magnet of the embodiment requires no adjustment process and manufacturing process can be simplified. The permanent magnet of the embodiment can thereby be manufactured with high dimensional accuracy.

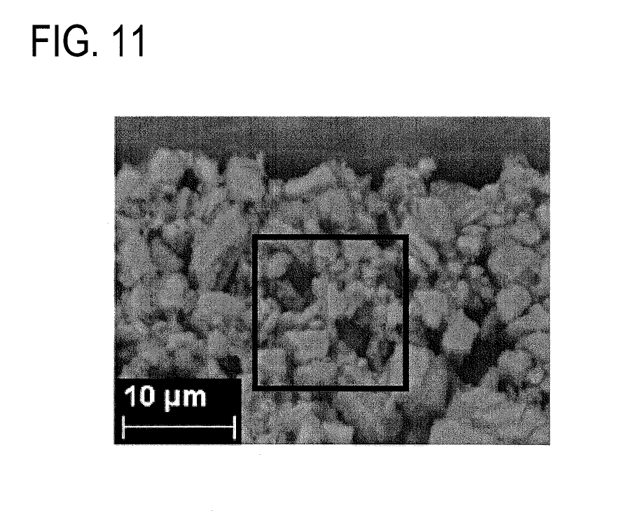

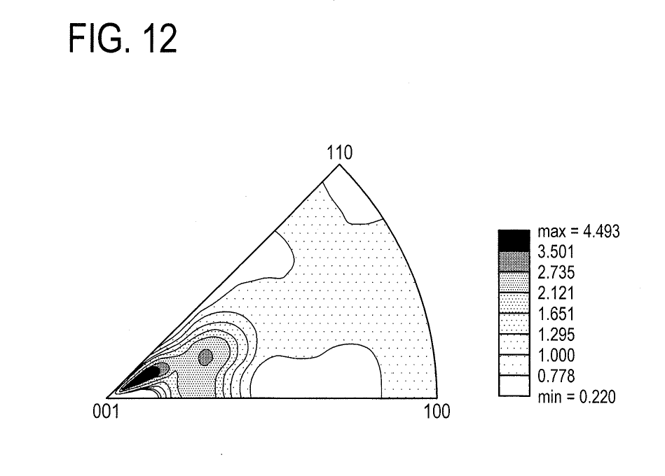

Meanwhile, FIG. 11 is an SEM image of a green sheet of the embodiment taken after magnetic field orientation in a direction perpendicular to a C axis (in other words, in an in-plane and transverse direction or in an in-plane and machine direction of the green sheet to which a magnetic field is applied). FIG. 12 is the inverse pole figure showing the crystal orientation distribution analyzed through an electron backscatter diffraction pattern analysis with respect to an area surrounded by a frame in FIG. 11. Referring to FIG. 12, there can be found that the magnetic field orientation of the magnet particles is rather oriented in a <001> direction than other directions, in the green sheet of the embodiment. That is, the magnetic field orientation is optimized in the embodiment, so that the magnetic properties of the permanent magnet can be improved. Incidentally, sintering of the green sheet thereafter can further help improve the direction of the magnetic field orientation of the magnet particles.

### (Comparison of Embodiment and Comparative Example 2)

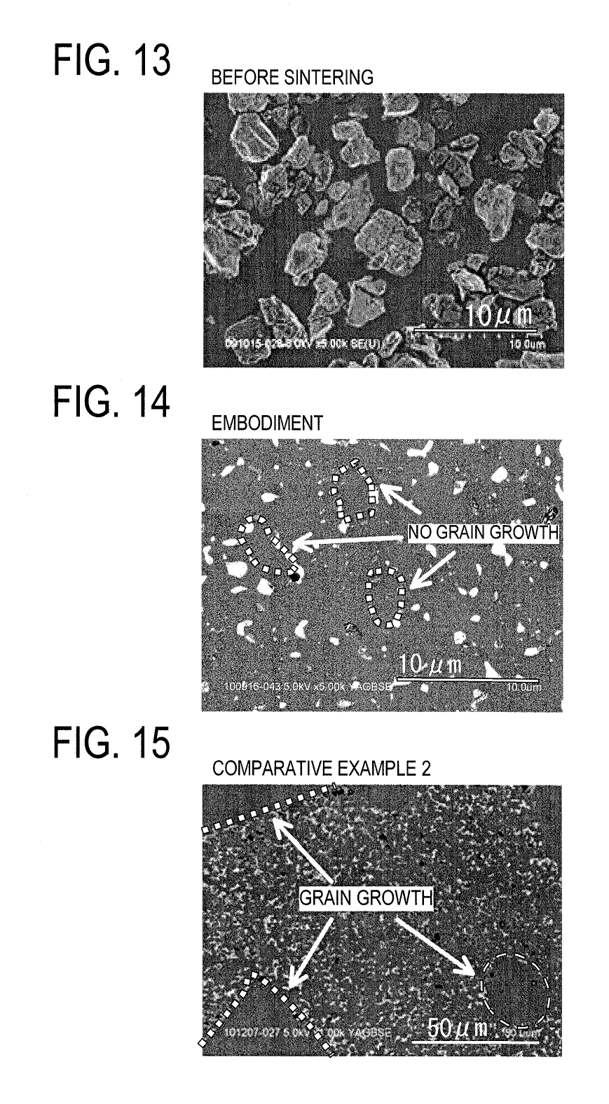

FIG. 13 is an SEM image of part of a formed body taken before sintering. FIG. 14 is an SEM image of part of a permanent magnet manufactured according to the embodiment. FIG. 15 is an SEM image of part of a permanent magnet manufactured according to a comparative example 2. In comparison with those SEM images, it is apparent that grain growth does not occur to the permanent magnet of the embodiment even after sintering; grain growth can be suppressed in the embodiment. Meanwhile, significant grain growth after sintering is observed in the permanent magnet of the comparative example 2. Thus, grain size does not change significantly in the sintered permanent magnet of the embodiment in comparison with the one before sintering; it is apparent that grain growth of magnetic particles during sintering is suppressed with respect to the permanent magnet of the embodiment. From the result, it is proved that pressure sintering such as spark plasma sintering, etc. achieves sintering of the permanent magnet at lower range of sintering temperature in comparison with vacuum sintering. Thereby, heating and holding periods in the sintering process can be shortened; so that a densely sintered body can be manufactured in which grain growth of the magnet particle is suppressed.

Further, as to shapes of the permanent magnets, the degree of warpage observed in the permanent magnet of the embodiment is less than that in the permanent magnet of the comparative example 2. That is, pressure sintering such as spark plasma sintering, etc. can suppress warpage in a sintered magnet more significantly in comparison with vacuum sintering.

As described in the above, according to the permanent magnet 1 and the method for manufacturing the permanent magnet 1 directed to the embodiment, magnet material is milled into magnet powder. Next, the magnet powder and a binder are mixed to obtain a mixture (slurry or a powdery mixture). Next, the thus prepared mixture is formed into long-sheet-like shape so as to obtain a green sheet 13. Before the thus formed green sheet 13 dries, magnetic field is applied in an in-plane and transverse direction or an in-plane and machine direction of the green sheet 13 for magnetic field orientation. Further, by performing pressure sintering, the permanent magnet 1 is manufactured. The thus sintered green sheet uniformly contracts and deformations such as warpage and depressions do not occur there. Further, the sintered green sheet having uniformly contracted gets pressed uniformly, which eliminates adjustment process to be conventionally performed after sintering and simplifies manufacturing process. Thereby, a permanent magnet can be manufactured with dimensional accuracy. Further, even if above such permanent magnets are made thin in the course of manufacturing, increase in the number of manufacturing processes can be avoided without lowering a material yield.

Further, before the green sheet 13 dries, magnetic field is applied in an in-plane and transverse direction or an in-plane and machine direction of the green sheet 13 for magnetic field orientation. Therefore, optimized magnetic field orientation can be performed and improvement of the magnetic properties of the permanent magnet is achieved. Further, there is no worry for the green sheet 13 to have a bristling-up surface when magnetic field is applied thereto.

Further, the green sheet 13 is formed by applying the slurry 12 to the substrate continuously conveyed, and the magnetic field orientation is performed through applying a magnetic field to the green sheet 13 which is continuously conveyed with the substrate. Accordingly, a continuous process can be achieved from the step of forming the green sheet till the step of orienting magnetic field. Thereby, the manufacturing process can be simplified and productivity can be improved.

Further, in the second manufacturing method, the green sheet 13 conveyed together with the substrate is made to pass through a solenoid 38 charged with electric current so as to apply magnetic field. Accordingly, homogeneous magnetic field can be applied to the green sheet 13 and homogeneous and optimized magnetic field orientation can be performed.

Further, the permanent magnet 1 is a pressure-sintered magnet. Pressure sintering makes it possible to lower sintering temperature so as to suppress the grain growth in sintering and magnetic performance can be improved. Further, the thus sintered magnet uniformly contracts and deformations such as warpage and depressions do not occur there. Further, the sintered magnet having uniformly contracted gets pressed uniformly, which eliminates adjustment process to be conventionally performed after sintering and simplifies manufacturing process. Thereby, a permanent magnet can be manufactured with dimensional accuracy. Further, even if above such permanent magnets are made thin in the course of manufacturing, increase in the number of manufacturing processes can be avoided without lowering a material yield.

Further, in the step of pressure sintering the green sheet, the green sheet is sintered by uniaxial pressure sintering such as spark plasma sintering, etc. Therefore, the thus sintered magnet uniformly contracts and deformations such as warpage and depressions can be prevented in the magnet.

Further, in the step of pressure sintering the green sheet, the green sheet is sintered by electric current sintering such as spark plasma sintering, etc. Thereby, quick heating and cooling can be realized and sintering in a lower temperature range can be realized, as well. As a result, the heating-up and holding periods in the sintering process can be shortened; so that a densely sintered body can be manufactured in which grain growth of the magnet particle is suppressed.

Further, before the step of sintering the green sheet 13, the binder is decomposed and removed from the green sheet by holding the green sheet for a predetermined length of time at binder decomposition temperature in a non-oxidizing atmosphere. Thereby, carbon content in the magnet can be reduced previously. Consequently, previous reduction of carbon content can prevent alpha iron from separating out in a main phase of the sintered magnet and the entirety of the magnet can be sintered densely. Thereby, decrease in the coercive force can be prevented.

Further, in the step of calcination, the green sheet 13 to which the binder has been mixed is held in a hydrogen atmosphere or a mixed gas atmosphere of hydrogen and inert gas for a predetermined length of time at temperature range of 200 through 900 degrees Celsius, more preferably, at 400 through 600 degrees Celsius. Thereby, carbon content in the magnet can be reduced reliably.

Not to mention, the present invention is not limited to the above-described embodiments but may be variously improved and modified without departing from the scope of the present invention.

Further, of magnet powder, milling condition, mixing condition, calcination condition, sintering condition, etc. are not restricted to conditions described in the embodiment. For instance, in the above described embodiment, magnet material is dry-milled by using a jet mill. Alternatively, magnet material may be wet-milled by using a bead mill. In the above-mentioned embodiment, the green sheet is formed in accordance with a slot-die system. However, a green sheet may be formed in accordance with other system or molding (e.g., calendar roll system, comma coating system, extruding system, injection molding, doctor blade system, etc.), as long as it is the system that is capable of forming slurry or fluid-state mixture into a green sheet on a substrate at high accuracy. Further, in the above embodiment, the magnet is sintered by SPS method; however, the magnet may be sintered by other pressure sintering methods (for instance, hot press sintering, etc.).

Further, in the above embodiment, a series of continuous processes is adopted for a coating process by the slot-die system and a magnetic field orientation process. However, a non-continuous process can be adopted for those processes. In such a case, the formed green sheet 13 may be cut in a predetermined length, and the magnetic field may be applied to the green sheet in a stopped state to perform the magnetic field orientation.

Further, the calcination process may be omitted. Even so, the binder is thermally decomposed during the sintering process and certain extent of decarbonization effect can be expected. Alternatively, the calcination process may be performed in an atmosphere other than hydrogen atmosphere.

Although resin, long-chain hydrocarbon, fatty acid methyl ester are mentioned as examples of binders in the embodiment, other material may be used.

Description of the present invention has been given by taking the example of the Nd—Fe—B-based magnet. However, magnet made of other kinds of material (for instance, cobalt magnet, alnico magnet, ferrite magnet, etc.) may be used. Further, in the embodiments of present invention, the proportion of Nd component ratio with reference to the alloy composition of the magnet is set higher in comparison with Nd component ratio in accordance with the stoichiometric composition. The proportion of Nd component may be set the same as the alloy composition according to the stoichiometric composition.

### DESCRIPTION OF REFERENCE NUMERALS AND SIGNS

1 permanent magnet
11 jet mill
12 slurry
13 green sheet
14 supporting substrate
15 slot die
25, 26 magnetic coils
30 formed body

1. A rare-earth permanent magnet manufactured through steps of:
milling magnet material into magnet powder;
preparing a mixture by mixing the magnet powder and a binder;
obtaining a green sheet by forming the mixture into a long-sheet-like shape;
applying magnetic field in an in-plane and transverse direction or an in-plane and machine direction of the green sheet for magnetic field orientation; and
sintering the green sheet subjected to the magnetic field orientation.

2. The rare-earth permanent magnet according to claim 1, wherein,
in the step of obtaining a green sheet, the green sheet is formed by applying the mixture onto a surface of a substrate that is continuously conveyed, and
in the step of applying magnetic field, magnetic field is applied to the green sheet that is continuously conveyed together with the substrate.

3. The rare-earth permanent magnet according to claim 2, wherein, in the step of applying magnetic field, the green sheet conveyed together with the substrate is made to pass through a solenoid charged with electric current so as to apply magnetic field in the in-plane and machine direction of the green sheet for the magnetic field orientation.

4. The rare-earth permanent magnet according to claim 1, wherein, in the step of sintering the green sheet, the green sheet is pressure sintered.

5. The rare-earth permanent magnet according to claim 1, wherein, before the step of sintering the green sheet, the binder is decomposed and removed from the green sheet by holding the green sheet for a predetermined length of time at binder decomposition temperature in a non-oxidizing atmosphere.

6. The rare-earth permanent magnet according to claim 5, wherein, when decomposing and removing the binder from the green sheet, the green sheet is held for the predetermined length of time at temperature range of 200 degrees Celsius to 900 degrees Celsius in a hydrogen atmosphere or a mixed gas atmosphere of hydrogen and inert gas.

7. The rare-earth permanent magnet according to claim 1, wherein,
the mixture is slurry prepared by mixing the magnet powder, the binder and an organic solvent, and
in the step of applying magnetic field, the magnetic field is applied to the green sheet before the green sheet dries.

8. A manufacturing method of a rare-earth permanent magnet comprising steps of:
milling magnet material into magnet powder;
preparing a mixture by mixing the magnet powder and a binder;
obtaining a green sheet by forming the mixture into a long-sheet-like shape;
applying magnetic field in an in-plane and transverse direction or an in-plane and machine direction of the green sheet for magnetic field orientation; and
sintering the green sheet subjected to the magnetic field orientation.

9. The manufacturing method of a rare-earth permanent magnet according to claim 8, wherein,
in the step of obtaining a green sheet, the green sheet is formed by applying the mixture onto a surface of a substrate that is continuously conveyed, and
in the step of applying magnetic field, the magnetic field is applied to the green sheet that is continuously conveyed together with the substrate.

10. The manufacturing method of a rare-earth permanent magnet according to claim 9, wherein, in the step of applying magnetic field, the green sheet conveyed together with the substrate is made to pass through a solenoid charged with electric current so as to apply magnetic field in the in-plane and machine direction of the green sheet for the magnetic field orientation.

11. The manufacturing method of a rare-earth permanent magnet according to claim 8, wherein, in the step of sintering the green sheet, the green sheet is pressure sintered.

12. The manufacturing method of a rare-earth permanent magnet according to claim 8, wherein, before the step of sintering the green sheet, the binder is decomposed and removed from the green sheet by holding the green sheet for a predetermined length of time at binder decomposition temperature in a non-oxidizing atmosphere.

13. The manufacturing method of a rare-earth permanent magnet according to claim 12, wherein, when decomposing and removing the binder from the green sheet, the green sheet is held for the predetermined length of time at temperature range of 200 degrees Celsius to 900 degrees Celsius in a hydrogen atmosphere or a mixed gas atmosphere of hydrogen and inert gas.

14. The manufacturing method of a rare-earth permanent magnet according to claim 8, wherein,
the mixture is slurry prepared by mixing the magnet powder, the binder and an organic solvent, and
in the step of applying magnetic field, the magnetic field is applied to the green sheet before the green sheet dries.
